(19) United States
(12) Patent Application Publication
(10) Pub. No.: US 2018/0349894 A1
(43) Pub. Date: Dec. 6, 2018

(54) SYSTEM OF HARDWARE AND SOFTWARE TO PREVENT DISCLOSURE OF PERSONALLY IDENTIFIABLE INFORMATION, PRESERVE ANONYMITY AND PERFORM SETTLEMENT OF TRANSACTIONS BETWEEN PARTIES USING CREATED AND STORED SECURE CREDENTIALS

(71) Applicants: Christos Patrinos, Newburyport, MA (US); Katherine Rand, Newbury, MA (US)

(72) Inventors: Christos Patrinos, Newburyport, MA (US); Katherine Rand, Newbury, MA (US)

(21) Appl. No.: 15/993,015

(22) Filed: May 30, 2018

Related U.S. Application Data
(60) Provisional application No. 62/512,679, filed on May 30, 2017.
(60) Provisional application No. 62/512,687, filed on May 30, 2017.
(60) Provisional application No. 62/512,690, filed on May 30, 2017.

(51) Int. Cl. G06Q 20/38; G06F 21/31

(52) U.S. Cl. CPC G06Q 20/3823; G06F 21/31; G06Q 20/3829; G06Q 20/38215

(57) ABSTRACT

An apparatus and method for performing anonymous settlement of transactions using secure credentials and a settlement service. Enrolled entity information is received. Linked accounts are designated. Encryption and secure credentials are provided by the settlement service. Linked accounts are debited to create an iteratively updated record to authenticate data. Data for a transaction is exchanged between a payee and the entity using a secure credential to remain anonymous. A private key is used by the entity to perform one or more of signing an amount requested and sending a certificate to the payee, as a commitment to pay by the settlement service. Entity records are updated with most recent certificate values, re-signed and sent to the settlement service. A payment request containing the amount and signed certificate are sent. The payment request is authenticated and linked accounts are debited and credited, then transaction results are stored.

### CROSS-REFERENCE TO RELATED APPLICATION(S)

This application claims priority to, and the benefit of, co-pending U.S. Provisional Application No. 62/512,679, filed May 30, 2017, U.S. Provisional Application No. 62/512,687, filed May 30, 2017, and U.S. Provisional Application No. 62/512,690, filed May 30, 2017, for all subject matter common to said applications. The disclosures of said provisional applications are hereby incorporated by reference in their entirety.

### FIELD OF THE INVENTION

The present invention relates to systems for securing personally identifiable information suitable for providing secure, trustworthy, payment services that may be used without disclosing personally identifiable information during transactions. In particular, the present invention provides systems that authenticate transaction participant information, provide authenticated, encrypted, credentials that may be used in lieu of account and personally identifying information, and carry out payment settlement on behalf of participants isolating preserving anonymity and preventing disclosure of personally identifiable information.

### BACKGROUND

Generally, the Internet and digital devices provide easy access to traditional and new, useful services. In exchange for such services, personally identifiable information is divulged, either explicitly on a web page, or implicitly in communication by devices, the engaged application or the protocol transmission, and then associated with digital information collected and maintained by those services including choices made by users. Once this information has been associated outside of the owner's control, revocable use of personally identifiable information and digital information reflecting choices is lost, effectively, forever. Ownership of information is replaced by a requirement that the source of the information have passive, complete trust in the conduct of the parties controlling the services as well as unknown partners and intermediaries, where privacy of information is subject to changeable terms and conditions. Additionally, digital settlement has eliminated the requirement of physical presence for each side in a transaction. This increases convenience but adds uncertainty to the issue of securing information used for transactions and services. Many attempts have been made to secure credit card identification and prevent fraudulent transactions. Historically, settlement was the exclusive domain of banks and very select providers and the systems in place were sufficient for the technology used and rapidly advanced the speed of business. Consumers sending simply encrypted account and personally identifiable information to a party in a transaction that in turn sent that information to a financial institution for verification while each entity in the chain stored the information in records was viable before digital settlement using digital devices again rapidly expanded the speed of business.

However, this technology experiences several shortcomings. Over one billion cards are in circulation and the limited technology designed into a card including static, eventually knowable factors are vulnerable as the number of transactions and parties with access to information increase. Financial institutions struggle to quickly and efficiently provide verification due to the amount of account and personally identifying information that must be transmitted and received. Financial institutions are also vulnerable to data breaches, and may themselves engage in activities that sell or otherwise transfer account and personally identifiable information. Conventional techniques proliferate personally identifiable information because every transaction requires divulging personally identifiable information held by the entity and/or entity's banking entity to the other party in the transaction. This information is repeatedly duplicated and transmitted, forever stripping the owner of the information from being able to protect and control the information.

### SUMMARY

Accordingly, there is a need for a system of settlement that recognizes the widespread use of digital devices and the inherent capacity of those devices and then uses the technological capabilities of those devices to advance business and enable broader delivery of more secure settlement services. A customer provisioned technology departs from conventional settlement structure and practices, fundamentally changing transaction settlement procedures and providing improvements over existing systems that yield near irrefutable, anonymous, secure, valid transactions and obfuscated individual digital choices. This technology imparts capabilities for transaction settlement without exchanging personally identifiable information that were not possible with conventional systems.

The present invention is directed toward further solutions to address this and other needs, in addition to having other desirable characteristics and benefits that will be appreciated by one of skill in the art upon reading the present specification.

In accordance with example embodiments of the present invention, a system is provided for performing anonymous settlement of transactions between parties. A settlement service manages one or more settlement devices and a cryptographically secure credentials device that an entity possesses and uses with an entity device having information comprising account information associated with the entity. The settlement service, the one or more settlement devices, one or more payee devices, the entity device and the credential device all communicate with each other. Settlement devices issue to the entity device enrolled with the settlement service a public key and a private key, using public key infrastructure with the settlement service as a certificate authority, and one or more unique symmetric encryption keys employing cryptographic techniques configured to encrypt communications and create and install credentials into the cryptographically secure credentials device. The one or more settlement devices perform authentication and designate a linked entity account from the account information and debit payment from the entity device to alter the linked entity account for use in authentication for settlement services. In response, the entity device creates a secure credential comprising at least one of the group consisting of a certificate and a version structured document, indicating an amount and signed by an entity private key, that then transforms into a current account transaction history that is appended with each transaction amount, iteratively updated with each new transaction, and securely stored in both a database of the settlement service associated with the entity and the entity device. The entity device communicates with a payee device of the one or more payee device anonymously using secured credentials the payee device accepts as sufficient for engaging in a transaction. The entity then confirms an amount requested, stipulated data and additional credential data from the payee, then uses the private key to sign the amount requested together with other data, and sends the certificate created by the entity device to the payee device as a commitment to pay by the settlement service acting as agent for the entity. The entity device then updates the current account transaction history with data from the certificate sent to the payee device, re-signs and sends a copy to the settlement service. The payee device sends the amount requested, the certificate, and information unique to the transaction to the settlement service in a payment settlement request. The one or more settlement devices authenticate the payment settlement request received from the payee device, using the amount requested approved by the payee certificate, and match the payee request and signed entity digital content, certificate credentials, and current account transaction history sent from the entity device. The one or more settlement devices complete the transaction between the entity device and the payee device, upon authentication, by debiting the linked entity account and crediting a designated destination belonging to the payee device, and then securely storing results of the transaction.

In accordance with aspects of the present invention, the cryptographically secure credentials device can include a hardware device, wherein the hardware device of the cryptographically secure credentials device is one of the group consisting of an external device, an external token, an external card, an internal device component, a subscriber identity module (SIM) card, an internal secure co-processor, and a field-programmable gate array (FPGA). The cryptographically secure credentials device can be possessed by the entity and leased to the entity by the settlement service. The account information can correspond with one of the group consisting of a credit card, debit card, bank account, vendor account, a social security number, membership identifier, report, and other personally identifiable transactable information. The entity device can be enrolled with the settlement service by providing a request containing information comprising authentication information and the account information, that is then authenticated by the settlement device based on the authentication information and the account information, wherein the one or more settlement devices are configured to authenticate the entity device using one or more of the group consisting of an asynchronous process and a paused then parallel process, wherein payment information must match components of the authenticating information provided by the entity device and establish a confirmation response from a trusted party and transmitted by one or more of the group consisting of the entity device to the settlement service and the settlement service to an authorized account of entity, to determine that a request is from an authorized device under an authorized policy of use, wherein an authentication result is available to be communicated. The one or more settlement devices can authenticate the entity device by a government authority, wherein the government authority functions as a trusted party and precedes payment and credential creation with a separated payment and the government authority confirmation responses as authentication for credential creation, wherein governmental authentication will verify the entity uniquely across a class of records of the government authority, and each government authority will be independently authorized with a rigorous and explicit identification process, creating credentials mandated to be stored on one or more of the group consisting of federal information processing standard publication 140-2 (FIPS-140-2) smart and Java cards, with card reading hardware, wherein verification by the government authority of the entity corporeally present and registered uniquely under the purview of the government authority will provide unique singular credential creation for that government authority. The government authority, authorized to produce said credentials by the settlement service and operating as a registration authority in a public key infrastructure architecture, can produce a first version of credentials and one of the group consisting of an X.509 certificate and a versioned structured document, and can produce a second version of credentials and one of the group consisting of an X.509 certificate and a versioned structured document, wherein the first version comprises information with no personally identifiable information therein, and wherein the second version comprises personally identifiable information that is publicly available and under control and maintenance by the government authority. The certificate can be a secure sealed digital object that cannot be changed after creation by the entity and contains use constraints comprising one or more of the group consisting of a single use X.509 certificate limiting the number of transactions that may be attempted and an expiry constraint, wherein the use constraints are stipulated in an ASN.1 extension that causes a transaction to be blocked when a use constraint is violated. The credentials can comprise one or more industry defined proprietary use ASN.1 data structures to store data unique to the type and use of the credential created, such that the data structure also comprises additional credential data and one or more encryption keys wrapped by the settlement device produced public key that are sent to the entity device and upon response are installed in the cryptographically secure credentials device. The one or more settlement devices can provide for the creation of many different credentials, differentiated by fee, data required, credential specific actions, and transaction specific actions triggered on behalf of the entity device, that are stored by the group consisting of one or more of the cryptographically secure credentials device, an X.509 certificate, an ASN.1 data structure, and version defined structured digitally signed document, wherein additional credential data comprises a non-personally identifying information data. The one or more settlement devices can distinguish credentials by labels that are offered for the entity device to use in a transaction and wherein the credentials are one more of the group consisting of defined type credentials and expandable type credentials.

In accordance with aspects of the present invention, the additional credential data can comprise GPS location data of the entity.

In accordance with aspects of the present invention, the communication can comprise one or more of the group consisting of electronic communication and wireless communication, and communication uses a communication protocol that is one of the group consisting of an industry standard and a vendor specific communications protocol. The communication can be presented to the entity using one or more of the group consisting of web page, text, short message service (SMS) and an application interface. The payee can be a second entity also enrolled to use the settlement service such that the settlement service achieves entity-to-entity payment that is agnostic to any communication protocol and preserves the anonymity of both the entity and the payee from each other where neither has access to any personally identifying information about any other party. The one or more settlement devices can authenticate, upon receipt of the certificate sent by the payee device and the current account transaction history sent from the entity device, the payment settlement request by retrieving the entity public key and testing any signature of the entity, testing the amount requested, testing use constraints, and test any additional information supplied in the payment settlement request received from the payee, using any amount approved by payee certificate, certificate credentials and current account transaction history sent from the entity, and upon positive authentication of the tests the one or more settlement devices securely store results and trigger actions associated with credentials used by the entity and requested responses. The designated destination belonging to the payee can comprise one of the group consisting of a payee secure credential, a payee settlement address linked account, and creation of a cryptographically generated and public key infrastructure generated digital object sent to the payee secure credential or settlement address.

In accordance with example embodiments of the present invention, a computer implemented method is provided for performing anonymous settlement of transactions between parties. One or more settlement devices managed by a settlement service receive information from an entity device possessed by an entity enrolled with the settlement service, wherein the information comprises account information associated the entity. The one or more settlement devices issue to the entity device, using a public key, a private key and one or more unique symmetric encryption keys configured to encrypt communications. The one or more settlement devices create and install credentials into a cryptographically secure credentials device. The one or more settlement devices designate a linked entity account from the account information. The one or more settlement devices authenticate and debit payment from the entity device to alter the linked entity account for use in authentication for settlement services. The entity device creates a secure credential comprising at least one of the group consisting of a certificate and a version structured document, indicating an amount and signed by an entity private key, that then transforms into a current account transaction history that is appended with each transaction amount, iteratively updated with each new transaction, and securely stored in both a database of the settlement service associated with the entity and the entity device. The entity device communicates with a payee device of one or more payee devices, by anonymously using secured credentials the payee device accepts as sufficient for engaging in a transaction. The entity device confirms an amount requested, stipulated data and additional credential data communicated from the payee device, and then uses the private key to sign the amount requested together with other data. The entity device sends the certificate created by the entity device to the payee device as a commitment to pay by the settlement service acting as agent for the entity. The payee device sends the certificate and information unique to the transaction to the settlement service in a payment settlement request. The entity device updates the current account transaction history with data from the certificate sent to the payee device, and re-signing and sending a copy to the settlement service. The one or more settlement devices authenticate the payment settlement request received from the payee device, using the amount requested approved by the payee certificate, certificate credentials, and current account transaction history sent from the entity device. The one or more settlement devices complete the transaction between the entity device and the payee device, upon authentication, by debiting the linked entity account and crediting a designated destination belonging to the payee device, and then securely storing results of the transaction.

In accordance with aspects of the present invention, the entity device can be enrolled with the settlement service by providing a request containing information from the entity device comprising authentication information and the account information, that is then authenticated by the settlement device, wherein to authenticate the entity device based on the authentication information and the account information the one or more settlement devices are configured to authenticate the entity device using an asynchronous process wherein payment information must match components of the authenticating information provided by the entity device and establish a confirmation response from a trusted party and transmitted by one or more of the group consisting of the entity device to the settlement service and the settlement service to an authorized account of entity, to determine that a request is from an authorized device under an authorized policy of use, and wherein the payee is a second entity also enrolled to use the settlement service such that the settlement service achieves entity-to-entity payment that preserves the anonymity of both the entity and the payee from each other where neither has access to any personally identifying information about any other party. The certificate can be a secure sealed digital object that cannot be changed after creation by the entity and contains use constraints comprising one or more of the group consisting of a single use X.509 certificate limiting the number of transactions that may be attempted and an expiry constraint, wherein the use constraints are stipulated in an ASN.1 extension that causes a transaction to be blocked when a use constraint is violated, and wherein credentials comprise one or more industry defined proprietary use ASN.1 data structures to store data unique to the type and use of the credential created, such that the data structure also comprises additional credential data and one or more encryption keys wrapped by the settlement device produced public key that are sent to the entity device and upon response are installed in the cryptographically secure credentials device.

In accordance with example embodiments of the present invention, a computer implemented method is provided for performing anonymous settlement of transactions between parties. One or more settlement devices provide secure credentials to an entity enrolled with a settlement service using an entity device and associated with a linked entity account for use in communication with a payee and authentication for settlement services. The entity device communicates with a payee device of one or more payee devices, using anonymous secured credentials the payee device accepts as sufficient for engaging in a transaction, wherein a payee holds an account with the settlement service to receive payment. The entity device sends the certificate created by the entity device to the payee device as a commitment to pay by the settlement service acting as agent for the entity. The settlement service pays a payee an amount requested using authenticated certificates signed by the entity to replace credit card and personally identifiable information thereby eliminating time consuming communications with financial institutions that require transmission and proliferation of account information and personally identifiable information.

In accordance with example embodiments of the present invention, a computer implemented method is provided for performing anonymous settlement of transactions between parties. One or more settlement devices managed by a settlement service receive information from an entity device possessed by an entity enrolled with the settlement service, wherein the information comprises account information associated the entity. The one or more settlement devices provide secure credentials to the entity device that replace account information and personally identifiable information, initiate and confirm a transaction anonymously, and indicate the settlement service shall make settlement payments on behalf of the entity device. The one or more settlement devices designate, from the account information, a linked entity account and debiting the linked entity account to initiate a current account transaction history shared only with the entity device and used with secure credentials to authenticate requests for payment. The one or more settlement devices receive, from a payee, an amount requested for payment settlement and confirmation credentials comprising a signed encrypted certificate obtained from the entity that requests the settlement service perform transactions with on behalf of the entity. The one or more settlement devices authenticate the amount requested received from the payee device and approved by the certificate obtained from the payee, using credentials, certificates, and current account transaction history sent from the entity device. The one or more settlement devices complete the transaction between the entity device and the payee device, upon authentication, by debiting the linked entity account and crediting a designated destination belonging to the payee device, and then securely storing results of the transaction and iteratively updating the current account transaction history for future authentication.

### BRIEF DESCRIPTION OF THE FIGURES

These and other characteristics of the present invention will be more fully understood by reference to the following detailed description in conjunction with the attached drawings, in which:

FIG. 1 is an illustrative diagram of an example embodiment of a system for performing one or more functions of the embodiments of the present invention;

FIG. 2 is an example of the system performing functions to provide credentials, authenticate and execute payment services for a transaction; and

FIG. 3 is an example computing device for implementing the system of FIG. 1 according to aspects of the present invention.

### DETAILED DESCRIPTION

An illustrative embodiment of the present invention relates to a system for performing anonymous settlement of transactions between parties using secure credentials and a settlement service that functions to authenticate information and provide credentials based on that information, thereby removing the need for parties to transmit extensive data to verify information. The settlement device additionally functions as an intermediary to settle payments between accounts using only secure credentials and without divulging any account or personally identifiable information. The system enables a settlement service to provide an entity with cryptography generated secure credentials that replace account information and personally identifiable information and can be used by the entity to initiate and approve transactions anonymously using the secure credentials to direct the settlement service to execute payment on behalf of the entity. The settlement service uses payment received from the entity for settlement services to create a private current account transaction history shared only with the entity and used in conjunction with secure credentials to authenticate requests for payment. Payment by the settlement service to a payee on behalf of the entity reduces opportunities for fraud, improves payment reliability, overcomes delays associated conventional data transmission for verification and preserves anonymity by never allowing a payee access to any entity account information or personally identifiable information belonging to the entity.

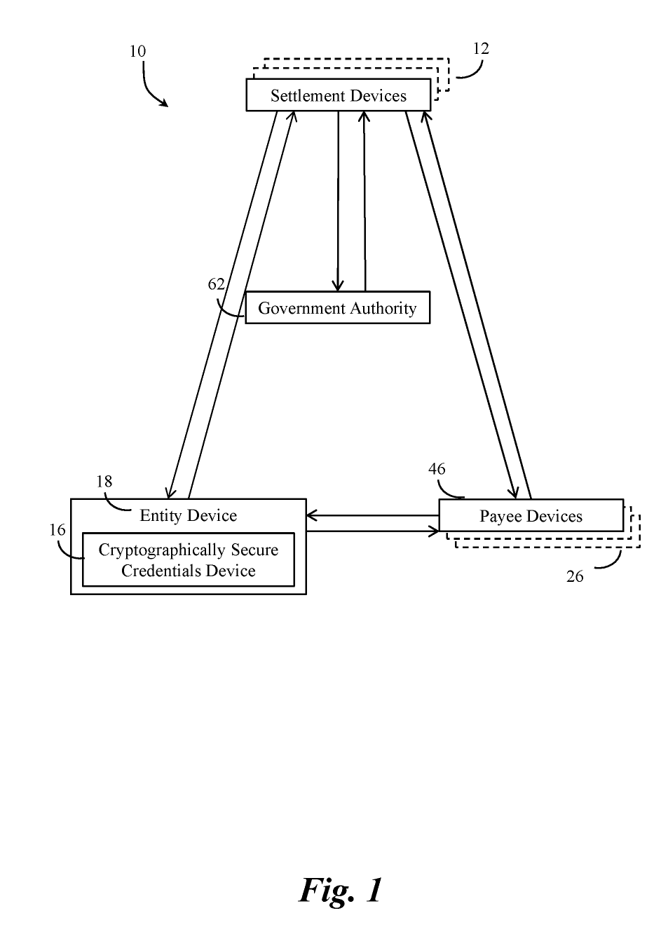

FIGS. 1 through 3, wherein like parts are designated by like reference numerals throughout, illustrate an example embodiment or embodiments of systems and methods for performing anonymous settlement of transactions between parties, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 depicts an example system 10 for performing various functions and methods of the embodiments of the present invention described herein. The system 10 generally can include one or more settlement devices 12 managed by a settlement service 14 that are in communication with an entity device 18 possessed by an entity 20 seeking settlement services and one or more payee devices 26. Both the settlement devices 12 and entity device 18 further interact with a cryptographically secure credentials device possessed by the entity 20 and operated in conjunction with the entity device 18. The settlement service 14 is engaged over any of multiple communication protocols, e.g. Wireless, wired, HTTP, HTTPS, Bluetooth®, IR, or other industry to vendor standard. The initial engagement of the settlement service 14 may authenticate entity credentials or may accept a third-party secure credential, or a third-party affirmation of authorization that may include a government authority 62 as a sufficient substitute for engaging the entity 20 and processing the transaction or service.

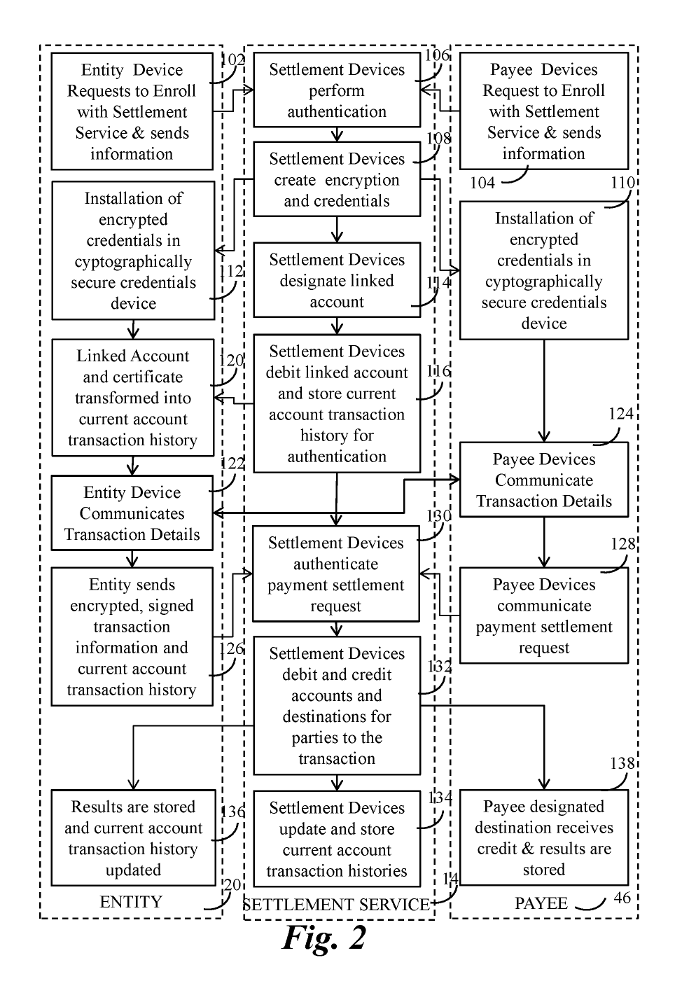

For example, FIG. 2 depicts the system 10 performing functions to provide credentials, authenticate information, and execute payment services for a transaction, and an example method for providing settlement services for a transaction between an entity 20 using an entity device 18 and a payee 46 using a payee device 26, according to an illustrative embodiment of the present invention. The one or more settlement devices 12 can be configured to receive many types of information related to an entity 20 that is seeking payment services that engages the settlement service 14 with an enrollment request. When the entity 20 initiates enrollment with the settlement service 14, the entity device 18 is enrolled with the settlement service 14 at (step 102), and the one or more settlement devices 12 are configured to authenticate the entity 20 (step 106) using the entity device 18 based on the authentication information and the account information. The entity 20 provides authenticating information and specific information for the credential type and a method of payment. The payment information must match the necessary authenticating components of the greater provided information. Other forms of authentication could be used; bank EFT, wire transfer, cc/debit card, and membership. This is an asynchronous/out of band process that establishes a known transaction request result with an accept/deny response from a trusted party either from entity 20 to service or from service to an authorized account of entity 20. Upon such a request from the entity 20, the settlement service 14 process authenticates the request is from an authorized device(s) under an authorized policy of use. The settlement service 14 process uses subscriber submitted form of payment as authentication of subscriber to/for the service and upon confirmation creates multiple unique digital objects in the credential creation phase of the service. The settlement service 14 produces minimally, a public/private key pair (either RSA, ECC, best practice or other industry standard asymmetric key public/private key pair), X.509 certificate or digitally signed vendor specific structured document and, optionally based on credential type, a symmetric encryption key, is produced then encrypted in the settlement service current credentials stored in the service provider's database. The settlement service 14 uses the settlement devices 12 to issue to the entity device 18 a public key and a private key using industry standard cryptography and one or more symmetric encryption keys using industry standard cryptographic techniques configured to encrypt communications (step 108). The settlement service may encrypt none/part/all of the transactions on its systems with its current credentials using public key infrastructure practices. The settlement service 14 implements best practices in the settlement with settlement service systems and account/card processor. The settlement service 14 produced public/private key pair and associated settlement service signed X.509 certificate have proprietary use but industry defined (ASN.1) data structures to store data unique to the type/use of the credential created. This may include non-personally identifiable information datum, other datum one or multiple encryption keys wrapped by the settlement service produced public key or the certificate signing request provided public key. At step 112, the settlement service 14 produced objects are sent to the entity 20 and upon response are installed in the cryptographically secure credentials device. This process may provide for the creation of many different credentials, differentiated by fee/no-fee or data required, that are stored by the credential and/or the X.509 certificate. Different credentials are distinguished by labels that are offered for a client-side device (lessee/owner) to use in creating a given transaction for a service, from either a settlement service 14 process or an authorized service. The settlement service 14 does not respond to unauthorized use of the credentials.

After successful authentication of the entity 20 via the entity device 18, the one or more settlement devices 12 are configured to designate a linked entity account (step 114) from the account information. This is followed by an unconventional step in which the entity 20 requesting use of the settlement service 14 is required to “pay” an amount for the service that is debited from the entity's linked account, but is not paid to any vendor payee in full or in part. This is unique as the settlement service 14 is the service and the payee. This serves to alter the linked entity account (step 116) for use in authentication for settlement services. Upon response from the settlement service 14, the entity 20 creates a X.509 certificate with ASN.1 encoding, or an entity's private key signed vendor specific document, indicating the starting amount, other data and signed by the entity's private key. This then becomes an available record of all transactions of the amount requested to be paid by the settlement service and is appended with each transaction amount (in plaintext), optionally including the payee's secure credential or settlement address, email, Bitcoin address, etc., possibly encrypted with the settlement service current public key, optionally other datum specified in the ASN.1 and digitally signed by the private key of the entity 20. The entity device 18 creates a secure credential, X.509 certificate or version specified structured document signed with the private key comprising a certificate or document indicating an amount and other data. The settlement service 14 also keeps an account of starting and all amounts and payee's secure credential or settlement address and additional ASN.1 specified data or specified designated datum. For either the settlement service 14 or the entity 20 this is called the current account transaction history (step 120) and transforms broader transaction history data into an efficient tool implemented for authentication. For the settlement service 14 it is stored, transaction-by-transaction or as the received by the entity 20, associated with the entity 20 in a database. For the entity 20 it is stored securely on the entity device 18. This current account transaction history can be provided by the settlement service 14 in the event of the entity 20 current account transaction history loss or entity device 18 loss and is accepted as authoritative for all amounts and transactions by all parties. The current account transaction history is appended with each transaction amount, iteratively updated with each new transaction.

With these features in place, the entity device 18 is configured to communicate at (step 122) with a payee device 46 of the one or more payee devices 26 anonymously using secured credentials the payee device 46 accepts as sufficient for engaging and consummating a transaction (step 124). A payee 46 is communicated with over a protocol and presents, minimally, the payee 46 secure credential or settlement address, amount requesting, GPS and optionally other datum, that is presented to the entity 20 via a web page, text, SMS or application interface, with industry/vendor communication protocol.

The installed settlement service 14 public key encrypts all information and is communicated to the settlement service. In accordance with an example embodiment, a certificate signing request (CSR) is generated automatically without entity 20 input, to be communicated to the settlement service or other credential and authenticating payment information as stipulated. With entity 20 third-party credentials secured on a device a payee 46 service is engaged over any of multiple communication protocols, e.g. Wireless, wired, HTTP, HTTPS, Bluetooth®, IR, or other industry to vendor standard. The initial engagement of the service accepts the third-party secure credential as a sufficient substitute for engaging the entity 20 and processing the transaction or service. The entity 20 confirms an amount requested, stipulated data and additional credential data from the payee 46, then use the private key to sign the amount requested together with other data, and send the certificate created by the entity device 18 to the payee device 46 as a commitment to pay by the settlement service 14 acting as agent for the entity 20, wherein the entity device 18 then updates the current account transaction history with data from the certificate sent to the payee device 46, re-signs and sends a copy (step 126) to the settlement service 14. Upon entity 20 acceptance of the full amount, the entity 20 creates a single use X.509 certificate with ASN.1 extensions to record the stipulated data and signs the X.509 certificate with the entity 20 private key. This, X.509 is a secure sealed digital object that cannot be changed and verified after the creation by the entity 20. Optionally, if enabled in the version, the entity 20 can confirm the amount requested is from payee 46 by confirming the payee signed amount, completing/rejecting the transaction. The entity 20, is not required to enter any Personally Identifying Information (PII), or optionally may enter non-personally identifiable information from the associated X.509 certificate. Any credential provided information must minimally exclude payment account and first and last name and other personally identifiable information, or be controlled as per the constraints of the third-party credential. This entity 20 created X.509 certificate is sent to the payee 46 as phase one of three (or optionally phase one of two) of the transactions and is the entity's commitment to pay by the entity's agent. This entity 20 X.509 certificate could be sent to the settlement service before/after/in lieu of sending to the payee 46. The entity 20 then updates current account transaction history with the same data as the payee 46 X.509 certificate, resigns and sends a copy to the settlement service 14 for phase two of three.

At step 128, the payee 46 device is configured to send the amount requested, and optionally, the certificate, and information unique to the transaction to the settlement service in a payment settlement request. The payee 46 uniquely presents to the entity 20 a mandatory confirmation of the amount or affirmation of completion of the service. This payee 46 request of payment by the entity 20 with the secured credentials is either through a service or directly on the entity device 18 by an application or a component on a web page. The entity 20, optionally with a completely automated public turing test to tell computers and humans apart (CAPTCHA) requirement, confirms the amount possibly twice, automatically runs software on the entity device 18 that uses the private key to sign payment amount or affirmation of completion of the service, along with other known datum possibly GPS or other. The entity 20 signature of the amount due, and of each of the known datum, and the entity 20 credential (corresponding to the public key and not an entity name thereby preserving anonymity) is sent to the payee 46 who then sends it to the settlement service 14 for payment. The settlement service 14, upon receipt of the payee's X.509 certificate or signed structured document, or optionally not until the current account transaction history from the entity 20, affects a debits of the linked account of the entity 20 and a credit to the payee's secure credential or settlement address linked account (step 138) or the creation of a cryptographically secure public key infrastructure generated digital object(s) sent to the payee's secure credential or settlement address (step 138). The amount is that approved by the entity 20 as stipulated in the payee's X.509 or last (most recent) in the entity's current account transaction history, with requisite expiry and single use constraints. Minimally that expiry or single use constraint is stipulated in the ASN.1 extension, or other designated constraint and used as parameter for the transaction each time. If the expiry or single use constraint is found in the query the transaction is blocked and actions triggered. Additional other factors may be used to prevent non-legitimate transactions. This is phase three of three and completes the transaction.

The one or more settlement devices 12 are configured to authenticate, at step 130, the payment settlement request received from the payee device 26, using the entity (payer) signed amount requested by the payee 46 certificate, certificate credentials, and current account transaction history sent from the entity device 18. The settlement service 14 provider retrieves the entity 20 public key and tests the signature and amount, plus any additional information, securely storing the results and upon confirmations processes settlement to the payee 46, debits the entity linked account either directly, indirectly or via card processor and the transaction is complete, with requisite expiry and single use constraints. This completes the transaction between the settlement service and the entity 20. There may be a fee applied to entity 20, payee 46 or both. The settlement service 14 upon, receipt of the payee's X.509 certificate or optionally not until the current account transaction history from the entity 20, affects payment settlement. The amount is that approved by the entity 20 as stipulated in the payee's X.509 or last in the entity's current account transaction history, with requisite expiry and single use constraints. Minimally that expiry or single use constraint is stipulated in the ASN.1 extension and used as parameter for the transaction each time. If the expiry or single use constraint is found in the query the transaction is blocked and actions triggered. Additional other factors may be used to prevent non-legitimate transactions.

The one or more settlement devices 12 are configured to complete the transaction (step 132) between the entity device 18 and the payee device, upon authentication, by debiting the linked entity account (step 136) and crediting a designated destination belonging to the payee device 26 (step 138), and then securely storing results of the transaction (step 134). The settlement service 14, upon receipt of the payee's X.509 certificate or optionally not until the current account transaction history from the entity 20, affects a debits of the entity's linked account and a credit to the payee's secure credential or settlement address linked account (step 138) or the creation of a cryptographically secure public key infrastructure generated digital object(s) sent to the payee's secure credential or settlement address (step 138). The amount is approved by the entity 20 as stipulated in the payee's X.509 or last in the entity's current account transaction history, with requisite expiry and single use constraints. This is phase three of three (or phase two of two if only the payee's record of transaction is sufficient) and completes the transaction. In some embodiments, the designated destination belonging to the payee 46 comprises one of the group consisting of a payee 46 secure credential, a payee 46 settlement address linked account, and creation of a cryptographically secure public key infrastructure generated digital object(s) sent to the payee 46 secure credential or settlement address.

In some embodiments, the cryptographically secure credentials device 16 comprises a hardware device 16 wherein the hardware device 16 of the cryptographically secure credentials device is one of the group consisting of an external device, an external token, an external card, an internal device component, a subscriber identity module (SIM) card, an internal secure co-processor, and a field-programmable gate array (FPGA). In further embodiments, the cryptographically secure credentials device is possessed by the entity 20 or leased to the entity by the settlement service 14 or a third party. The entity 20 communicates over a network with an entity 20 purchased/provided device, which is either leased or owned and configured with the settlement service 14 current credentials in a cryptographically secure environment.

In some embodiments, The system 10 may incorporate other account information corresponds with one of the group consisting of a credit card, debit card, bank account, vendor account and a social security number. The entity 20 provides authenticating information and specific information for the credential type and a method of payment. The payment information must match the necessary authenticating components of the greater provided information. Other forms of authentication may be used; bank EFT, wire transfer, cc/debit card, and membership. An additional type of credential is account based where the entity 20 authenticates with an account that the entity 20 requests the settlement service 14 to perform transactions with on behalf of the entity 20. The account may be a credit/debit card, bank account, vendor account, SSN#, membership, report, or other personally identifiable transactable information. The process of entity 20 request, settlement service 14 creation and entity 20 storage in a cryptographically secure device/component is as discussed.

In some embodiments, communication comprises one or more of the group consisting of electronic communication and wireless communication, and communication uses a communication protocol that is an industry standard or vendor specific communications protocol. With entity 20 third-party credentials secured on a device a payee 46 service is engaged over any of multiple communication protocols, e.g. Wireless, wired, HTTP, HTTPS, Bluetooth, IR, or other industry to vendor standard. In further embodiments, communication is presented to the entity 20 using one or more of the group consisting of web page, text, short message service (SMS) and an application interface. A payee 46 is communicated with over a protocol and presents, minimally, the payee 46 secure credential or settlement address, amount requesting, GPS and optionally other datum, that is presented to the entity 20 via a web page, text, SMS or application interface, with industry/vendor communication protocol.

In some embodiments, the entity device 18 is enrolled with the settlement service 14 by providing a request containing the authentication information and the account information, and wherein to authenticate the entity device 18 based on the authentication information and the account information the one or more settlement devices are configured to authenticate the entity device 18 using an asynchronous process wherein payment information must match components of the authenticating information provided by the entity device 18 and establish a confirmation response from a trusted party and transmitted by one or more of the group consisting of the entity device 18 to the settlement service 14 and the settlement service 14 to an authorized account of entity 20, to determine that a request is from an authorized device under an authorized policy of use. The entity 20 provides authenticating information and specific information for the credential type and a method of payment. The payment information must match the necessary authenticating components of the greater provided information. Other forms of authentication may be used; bank EFT, wire transfer, cc/debit card, and membership. This is an asynchronous/out of band process that establishes a known transaction request result with an accept/deny response from a trusted party either from entity 20 to service or from service to an authorized account of entity 20.

In some embodiments, the one or more settlement devices 12 are further configured to authenticate the entity device 18 by additional authentication by a government authority 62, wherein the government authority 62 functions as a trusted party and replaces payment and credential creation with a separated payment and the government authority 62 confirmation responses as authentication for credential creation, wherein governmental authentication will verify the entity 20 uniquely across a class of records of the government authority 62, and each government authority 62 will be independently authorized with a rigorous and explicit identification process, creating credentials mandated to be stored on one or more of the group consisting of federal information processing standard (FIPS) Publication 140-2 (FIPS-140-2) smart and Java cards, with card reading hardware, wherein verification by the government authority 62 of the entity 20 corporeally present and registered uniquely under the purview of the government authority 62 will provide unique singular credential creation for that government authority 62. The system provides for creation of unique authenticated anonymous (AA) credential that is guaranteed to be only a single copy. (The previous embodiment could have credentials authenticated for each credit card, membership, or multiple authorized authorities.) This is done by replacing payment/credential creation with a separated payment and governmental authority confirm/deny as authentication for credential creation. The governmental authentication will verify the subscriber uniquely across that authority's (e.g. local City Clerk resident/voter rolls) class of records. Each government authority 62 will be independently authorized with a more rigorous and explicit identification process similar to that described above, creating credentials mandated to be stored on FIPS-140-2 smart/Java cards with mandated card reading hardware. The embodiment with the highest level of irrefutability is the client-side storage of credentials in a FIPS-140-2 hardware device; currently token or smart/Java card. Such a device must comply with industry standards of data integrity, industry certifications of security compliance, secure one-way public/private/symmetric key storage, hardware prevention of critical key material readout, and no known backdoors. That governmental authority's verification of that exact entity 20 corporeally present and registered uniquely under the purview of that authority, by the settlement service 14 process will guarantee unique singular credential creation for that government authority 62. There will be a fee paid to the authority from the subscriber's payment cycle by the service provider. That fee may be one-time or recurring. In further embodiments, installation into a FIPS-140 device is replaced with the creation and delivery of the same/derived/linked digital objects in a password-encrypted object/file. This file can be used as an alternative web/client-side engagements. This can allow “over-the-air” OTA installation via (cellular, cellular data, Internet, Bluetooth or other industry standard wireless/wired protocols) into cell phones, tablets or other devices.

In some embodiments, the certificate is a secure sealed digital object that cannot be changed after creation by the entity 20 and contains use constraints comprising one or more of the group consisting of a single use X.509 certificate limiting the number of transactions that may be attempted and an expiry constraint, wherein the use constraints are stipulated in an ASN.1 extension that causes a transaction to be blocked when a use constraint is violated. Upon entity 20 acceptance of the full amount, the entity 20 creates a single use X.509 certificate with ASN.1 extensions to record the stipulated data and signs the X.509 certificate with the entity 20 private key. This, X.509 is a secure sealed digital object that cannot be changed and verified after the creation by the entity 20. Optionally, if enabled in the version, the entity 20 can confirm the amount requested is from payee 46 by confirming the signed amount, completing/rejecting the transaction.

In some embodiments, credentials are put in a KeyStore that is PIN protected from readout access and use an X.509 certificate or a digitally signed vendor specific structured document.

In some embodiments, credentials comprise one or more industry defined proprietary use ASN.1 data structures to store data unique to the type and use of the credential created, such that the data structure also comprises additional credential data and one or more encryption keys wrapped by the settlement device produced public key that are sent to the entity 20 device and upon response are installed in the cryptographically secure credentials device. The settlement service 14 produced public/private key pair and associated settlement service 14 signed X.509 certificate have proprietary use but industry defined (ASN.1) data structure to store data unique to the type/use of the credential created. This may include non-personally identifiable information datum, other datum one or multiple encryption keys wrapped by the settlement service 14 produced public key or the certificate signing request provided public key. At step 112, the settlement service 14 produced objects are sent to the entity 20 and upon response are installed in the cryptographically secure device/component. This process may provide for the creation of many different credentials, differentiated by fee/no-fee or data required, that are stored by the credential and/or the X.509 certificate.

In some embodiments, the one or more settlement devices 12 are configured to provide for the creation of many different credentials, differentiated by fee and data required, that are stored by the group consisting of one or more of the cryptographically secure credentials device, an X.509 certificate, and an ASN.1 data structure, wherein additional credential data comprises a non-personally identifying information data. For example some credentials are differentiated by fee/no-fee or data required, and stored by the credential and/or the X.509 certificate. Credentialing is distinguished by labels that are offered for a client-side device (lessee/owner) to use in creating a given transaction for a service, from either the credential granting settlement service 14 process or an authorized service. The settlement service 14 will not respond to unauthorized use of the credentials. In further embodiments, the one or more settlement devices are further configured to distinguish credentials by labels that are offered for the entity device 18 to use in a transaction and wherein the credentials are one more of the group consisting of defined type credentials and expandable type credentials.

In some embodiments, the additional credential data comprises GPS location data of the entity 20. The entity 20, optionally with a completely automated public Turing Test to tell computers and humans apart (CAPTCHA) requirement, confirms the amount possibly twice, automatically runs software on the entity device 18 that uses the private key to sign payment amount or affirmation of completion of the service, along with other known datum possibly GPS or other. The entity 20 signature of the amount due, and of each of the known datum, and the entity 20 credential is sent to the payee 46 who then sends it to the settlement service 14 for payment.

In some embodiments, complexity is reduced while still preserving anonymity where a vendor does not require created secured credentials but does require an account with the settlement service to receive the entity's payment. The entity, with settlement service granted credentials, signs the payee amount, and sends that signature, amount, and entity credential. The entity credential may be a flattened entity public key or a settlement service credit-card-style number where either or both are in the settlement created credential being so used. The entity sends this data to the payee, received at the payee's webpage or received at other locations or by other protocols known in the art. The payee then sends this data to the settlement service, possibly including other information designating payee merchant account. The settlement service retrieves the entity public key or uses the key in the message if detected, compares the signature to the plaintext amount, and if correct processes payment. Processing comprises unwrapping the entity personally identifiable information and account data encrypted with one or the current settlement service current private key, retrieving the account and processing the requested transaction. Thus the payee does nothing other than send the received content to the settlement service with a request to pay.

In some embodiments, the payee 46 is a second entity 20 also enrolled to use the settlement service 14 (step 104) such that the settlement service 14 achieves entity-to-entity payment that is agnostic to any communication protocol and preserves the anonymity of both the entity 20 and the payee 46 (step 110) from each other where neither has access to any personally identifying information about any other party. This transactions is irrefutable, only the payer could create the X.509 certificates and anonymous procedures. It is the third-party secure credentials on the entity's secure device/component and the entity 20 private key signature of the purchase/affirmation of the transaction by that makes the account transaction uniquely valid, payer obfuscated to the payee 46 and secure.

In some embodiments, the certificate sent by the payee 46 device and the current account transaction history sent from the entity 20 device, the one or more settlement devices 12 are configured to authenticate the payment settlement request by retrieving the entity 20 public key and testing any signature of the entity 20, testing the amount requested, testing use constraints, and test any additional information supplied in the payment settlement request received from the payee 46, using any amount approved and reflected in the payee 46 certificate (where software constraints prevent creation of X.509 certificate in an amount not equal to the entity approved payee requested amount), certificate credentials and current account transaction history sent from the entity 20, and upon authentication the one or more settlement devices securely store results. The settlement service 14 provider retrieves the entity 20 public key and tests the signature and amount, plus any additional information, securely storing the results and upon confirmations processes settlement to the payee 46, debits the entity 20 linked account either directly, indirectly or via card processor and the transaction is complete, with requisite expiry and single use constraints. With credentials so established, and via the process of encryption, public key infrastructure operations, signing and verification of phases by the system provider, an entity 20 can engage in irrefutable and obfuscated transactions. The settlement service 14 never will accept or process a transaction that reveals the identification of the entity 20. The settlement service 14, however, complies with all domiciled laws and authorities.

As an illustrative example that in no way limits the scope of the present invention, the system 10 creates a class of credentials that are not stored, but encrypted and saved on the server, and downloaded each time an authorized subscriber engages a so-configured requisite service. Then, and only then, the credentials are installed/deleted/blocked on the cryptographic secured card/token/device.

As an additional illustrative example that in no way limits the scope of the present invention, the system 10 replaces the installation into a FIPS-140 device, with the creation and delivery of the same/derived/linked digital objects in a password-encrypted object/file. This file can be used as an alternative web/client-side engagements. This can allow “over-the-air” OTA installation via (cellular, cellular data, Internet, Bluetooth or other industry standard wireless/wired protocols) into cell phones, tablets or other devices. Any type of credential may have associated with it actions that upon the signed proven request with the credential public key and other factors as necessary, actions(s) will be executed. Those actions may be the generation of additional digital objects, associated storage of digital objects, tracking, transactions or other functions. There may be additional novel services that use these credentials. The settlement, which may include or use a credential service, will minimally provide the credential.

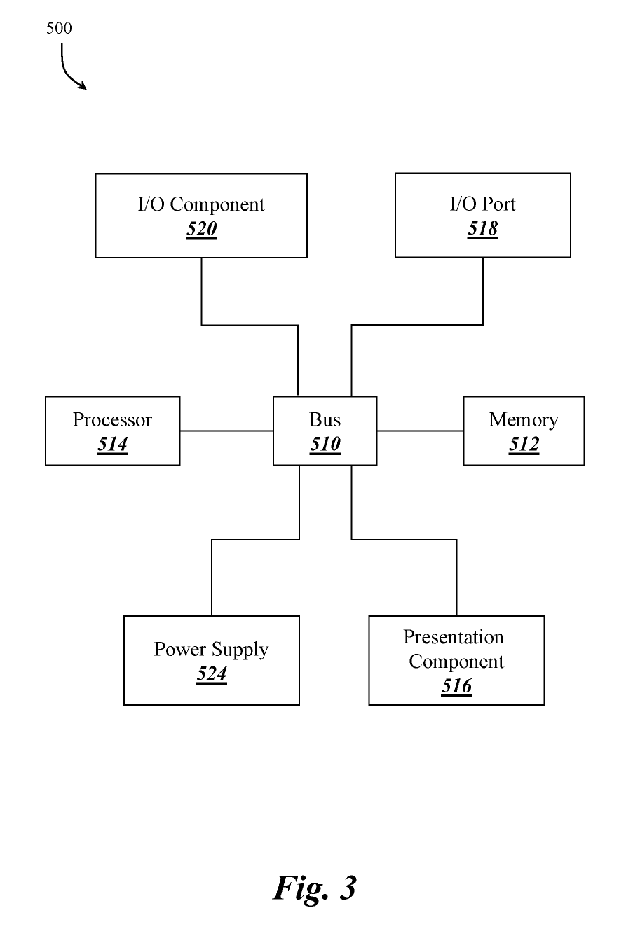

FIG. 3 illustrates an example of a computing device 500 for implementing illustrative systems and methods of the present invention. The computing device 500 is merely an illustrative example of a suitable computing environment and in no way limits the scope of the present invention. A “computing device,” as represented by FIG. 3, can include a “workstation,” a “server,” a “laptop,” a “desktop,” a “hand-held device,” a “mobile device,” a “tablet computer,” or other computing devices, as would be understood by those of skill in the art. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, where the one or more settlement devices 12, the one or more payee devices 26, the credentials device 16, and the entity device 18 may all be examples of a computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 524. One of skill in the art will appreciate that the bus 510 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 3 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 512 can include computer-storage media in the form of volatile and/or nonvolatile memory. The memory 512 may be removable, non-removable, or any combination thereof. Exemplary hardware devices are devices such as hard drives, solid-state memory, optical-disc drives, and the like. The computing device 500 can include one or more processors that read data from components such as the memory 512, the various I/O components 520, etc. Presentation component(s) 516 present data indications to a user or other device. Exemplary presentation components include a display device, speaker, printing component, vibrating component, etc.

The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, networking device, and the like.

One of skill in the art will appreciate a wide variety of ways to modify and alter the system 10 of FIG. 1, as well as the various components with which it interacts. For example, the one or more databases 44 can be implemented according to any number of suitable database structures. Furthermore, some or all of the information contained in the one or more databases 44 alternatively can be stored in one or more remote databases (e.g., cloud databases, virtual databases, and any other remote database). Additionally, although the components of FIG. 1 are depicted as discrete blocks and elements, in fact the system 10 may be implemented in such a way that multiple of the depicted modules, engines, or other components are implemented with just a single module, engine, or component. Similarly, in some embodiments it may be desirable to implement the system 10 using multiple iterations of the depicted modules, engines, and/or other components, as would be appreciated by one of skill in the art. Furthermore, while some modules and components are depicted as included within the system 10, it should be understood that, in fact, any of the depicted modules alternatively can be excluded from the system 10 and included in a different system. One of skill in the art will appreciate a variety of other ways to expand, reduce, or otherwise modify the system 10 upon reading the present specification.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A system for performing anonymous settlement of transactions between parties, the system comprising:
one or more settlement devices managed by a settlement service;
a cryptographically secure credentials device;
an entity device of an entity, the entity device having information comprising account information associated therewith;
one or more payee devices;
the one or more settlement devices, the settlement service, the one or more payee devices, the credentials device, and the entity device, being in communication;
wherein the entity device is enrolled with the settlement service, and the one or more settlement devices are configured to issue to the entity device a public key and a private key, using public key infrastructure, wherein the settlement service is a certificate authority, and one or more unique symmetric encryption keys employing cryptographic techniques configured to encrypt communications, and create and install credentials into the cryptographically secure credentials device;
wherein the one or more settlement devices are configured to perform authentication and designate a linked entity account from the account information and debit payment from the entity device to alter the linked entity account for use in authentication for settlement services;
wherein the entity device creates a secure credential comprising at least one of the group consisting of a certificate and a version structured document, indicating an amount and signed by an entity private key, that then transforms into a current account transaction history that is appended with each transaction amount, iteratively updated with each new transaction, and securely stored in both a database of the settlement service associated with the entity and the entity device;
wherein the entity device is configured to communicate with a payee device of the one or more payee device anonymously using secured credentials the payee device accepts as sufficient for engaging in a transaction, and then confirm an amount requested, stipulated data and additional credential data from the payee, then use the private key to sign the amount requested together with other data, and send the certificate created by the entity device to the payee device as a commitment to pay by the settlement service acting as agent for the entity, wherein the entity device then updates the current account transaction history with data from the certificate sent to the payee device, re-signs and sends a copy to the settlement service;
wherein the payee device is configured to send the amount requested, the certificate, and information unique to the transaction to the settlement service in a payment settlement request;
wherein the one or more settlement devices are configured to authenticate the payment settlement request received from the payee device, using the amount requested approved by the payee certificate, and match the payee request and signed entity digital content, certificate credentials, and current account transaction history sent from the entity device; and
wherein the one or more settlement devices are configured to complete the transaction between the entity device and the payee device, upon authentication, by debiting the linked entity account and crediting a designated destination belonging to the payee device, and then securely storing results of the transaction.

2. The system of claim 1, wherein the cryptographically secure credentials device comprises a hardware device, wherein the hardware device of the cryptographically secure credentials device is one of the group consisting of an external device, an external token, an external card, an internal device component, a subscriber identity module (SIM) card, an internal secure co-processor, and a field-programmable gate array (FPGA).

3. The system of claim 1, wherein the cryptographically secure credentials device is possessed by the entity and leased to the entity by the settlement service.

4. The system of claim 1, wherein the account information corresponds with one of the group consisting of a credit card, debit card, bank account, vendor account, a social security number, membership identifier, report, and other personally identifiable transactable information.

5. The system of claim 1, wherein the entity device is enrolled with the settlement service by providing a request containing information comprising authentication information and the account information, that is then authenticated by the settlement device based on the authentication information and the account information, wherein the one or more settlement devices are configured to authenticate the entity device using one or more of the group consisting of an asynchronous process and a paused then parallel process, wherein payment information must match components of the authenticating information provided by the entity device and establish a confirmation response from a trusted party and transmitted by one or more of the group consisting of the entity device to the settlement service and the settlement service to an authorized account of entity, to determine that a request is from an authorized device under an authorized policy of use, wherein an authentication result is available to be communicated.

6. The system of claim 5, wherein the one or more settlement devices are further configured to authenticate the entity device by a government authority, wherein the government authority functions as a trusted party and precedes payment and credential creation with a separated payment and the government authority confirmation responses as authentication for credential creation, wherein governmental authentication will verify the entity uniquely across a class of records of the government authority, and each government authority will be independently authorized with a rigorous and explicit identification process, creating credentials mandated to be stored on one or more of the group consisting of federal information processing standard publication 140-2 (FIPS-140-2) smart and Java cards, with card reading hardware, wherein verification by the government authority of the entity corporeally present and registered uniquely under the purview of the government authority will provide unique singular credential creation for that government authority.

7. The system of claim 6, wherein credentials produced by the government authority, authorized to produce said credentials by the settlement service, operating as a registration authority in a public key infrastructure architecture, produces a first version of credentials and one of the group consisting of an X.509 certificate and a versioned structured document, and a second version of credentials and one of the group consisting of an X.509 certificate and a versioned structured document, wherein the first version comprises information with no personally identifiable information therein, and wherein the second version comprises personally identifiable information that is publicly available and under control and maintenance by the government authority.

8. The system of claim 1, wherein the certificate is a secure sealed digital object that cannot be changed after creation by the entity and contains use constraints comprising one or more of the group consisting of a single use X.509 certificate limiting the number of transactions that may be attempted and an expiry constraint, wherein the use constraints are stipulated in an ASN.1 extension that causes a transaction to be blocked when a use constraint is violated.

9. The system of claim 1, wherein credentials comprise one or more industry defined proprietary use ASN.1 data structures to store data unique to the type and use of the credential created, such that the data structure also comprises additional credential data and one or more encryption keys wrapped by the settlement device produced public key that are sent to the entity device and upon response are installed in the cryptographically secure credentials device.

10. The system of claim 1, wherein the one or more settlement devices are configured to provide for the creation of many different credentials, differentiated by fee, data required, credential specific actions, and transaction specific actions triggered on behalf of the entity device, that are stored by the group consisting of one or more of the cryptographically secure credentials device, an X.509 certificate, an ASN.1 data structure, and version defined structured digitally signed document, wherein additional credential data comprises a non-personally identifying information data.

11. The system of claim 1, wherein the one or more settlement devices are further configured to distinguish credentials by labels that are offered for the entity device to use in a transaction and wherein the credentials are one more of the group consisting of defined type credentials and expandable type credentials.

12. The system of claim 1, wherein the additional credential data comprises GPS location data of the entity.

13. The system of claim 1, wherein communication comprises one or more of the group consisting of electronic communication and wireless communication, and communication uses a communication protocol that is one of the group consisting of an industry standard and a vendor specific communications protocol.

14. The system of claim 1, wherein communication is presented to the entity using one or more of the group consisting of web page, text, short message service (SMS) and an application interface.

15. The system of claim 1, wherein the payee is a second entity also enrolled to use the settlement service such that the settlement service achieves entity-to-entity payment that is agnostic to any communication protocol and preserves the anonymity of both the entity and the payee from each other where neither has access to any personally identifying information about any other party.

16. The system of claim 1, wherein upon receipt of the certificate sent by the payee device and the current account transaction history sent from the entity device, the one or more settlement devices are configured to authenticate the payment settlement request by retrieving the entity public key and testing any signature of the entity, testing the amount requested, testing use constraints, and test any additional information supplied in the payment settlement request received from the payee, using any amount approved by payee certificate, certificate credentials and current account transaction history sent from the entity, and upon positive authentication of the tests the one or more settlement devices securely store results and trigger actions associated with credentials used by the entity and requested responses.

17. The system of claim 1, wherein the designated destination belonging to the payee comprises one of the group consisting of a payee secure credential, a payee settlement address linked account, and creation of a cryptographically generated and public key infrastructure generated digital object sent to the payee secure credential or settlement address.

18. A computer implemented method for performing anonymous settlement of transactions between parties, the method comprising:
receiving, at one or more settlement devices managed by a settlement service, information from an entity device possessed by an entity enrolled with the settlement service, wherein the information comprises account information associated therewith;
issuing to the entity device, using the one or more settlement devices, a public key, a private key and one or more unique symmetric encryption keys configured to encrypt communications;
creating using the one or more settlement devices, credentials and installing the credentials into a cryptographically secure credentials device;
designating, by the one or more settlement devices, a linked entity account from the account information;
authenticating and debiting, using the one or more settlement devices, payment from the entity device to alter the linked entity account for use in authentication for settlement services;
creating, using the entity device, a secure credential comprising at least one of the group consisting of a certificate and a version structured document, indicating an amount and signed by an entity private key, that then transforms into a current account transaction history that is appended with each transaction amount, iteratively updated with each new transaction, and securely stored in both a database of the settlement service associated with the entity and the entity device;
communicating, using the entity device and a payee device of one or more payee devices, by anonymously using secured credentials the payee device accepts as sufficient for engaging in a transaction;
confirming, using the entity device, an amount requested, stipulated data and additional credential data communicated from the payee device, and then using the private key to sign the amount requested together with other data;
sending the certificate created by the entity device to the payee device as a commitment to pay by the settlement service acting as agent for the entity;
sending, using the payee device, the amount requested, the certificate, and information unique to the transaction to the settlement service in a payment settlement request;
updating, using the entity device, the current account transaction history with data from the certificate sent to the payee device, and re-signing and sending a copy to the settlement service;
authenticating, using the one or more settlement devices, the payment settlement request received from the payee device, using the amount requested approved by the payee certificate, certificate credentials, and current account transaction history sent from the entity device; and
completing, using the one or more settlement devices, the transaction between the entity device and the payee device, upon authentication, by debiting the linked entity account and crediting a designated destination belonging to the payee device, and then securely storing results of the transaction.

19. The method of claim 18, wherein the entity device enrolled with the settlement service is enrolled by providing a request containing information from the entity device comprising authentication information and the account information, that is then authenticated by the settlement device, wherein to authenticate the entity device based on the authentication information and the account information the one or more settlement devices are configured to authenticate the entity device using an asynchronous process wherein payment information must match components of the authenticating information provided by the entity device and establish a confirmation response from a trusted party and transmitted by one or more of the group consisting of the entity device to the settlement service and the settlement service to an authorized account of entity, to determine that a request is from an authorized device under an authorized policy of use, and wherein the payee is a second entity also enrolled to use the settlement service such that the settlement service achieves entity-to-entity payment that preserves the anonymity of both the entity and the payee from each other where neither has access to any personally identifying information about any other party.

20. The method of claim 18, wherein the certificate is a secure sealed digital object that cannot be changed after creation by the entity and contains use constraints comprising one or more of the group consisting of a single use X.509 certificate limiting the number of transactions that may be attempted and an expiry constraint, wherein the use constraints are stipulated in an ASN.1 extension that causes a transaction to be blocked when a use constraint is violated, and wherein credentials comprise one or more industry defined proprietary use ASN.1 data structures to store data unique to the type and use of the credential created, such that the data structure also comprises additional credential data and one or more encryption keys wrapped by the settlement device produced public key that are sent to the entity device and upon response are installed in the cryptographically secure credentials device.

21. A computer implemented method for performing anonymous settlement of transactions between parties, the method comprising:
providing, using one or more settlement devices, secure credentials to an entity enrolled with a settlement service using an entity device and associated with a linked entity account for use in communication with a payee and authentication for settlement services;
communicating, using the entity device and a payee device of one or more payee devices, using anonymous secured credentials the payee device accepts as sufficient for engaging in a transaction, wherein a payee holds an account with the settlement service to receive payment;
sending the certificate created by the entity device to the payee device as a commitment to pay by the settlement service acting as agent for the entity;
paying a payee an amount requested using the settlement service and authenticated certificates signed by the entity to replace credit card and personally identifiable information thereby eliminating time consuming communications with financial institutions that require transmission and proliferation of account information and personally identifiable information.

22. A computer implemented method for performing anonymous settlement of transactions between parties, the method comprising:
receiving, at one or more settlement devices managed by a settlement service, information from an entity device possessed by an entity enrolled with the settlement service, wherein the information comprises account information associated therewith;
providing secure credentials to the entity device that replace account information and personally identifiable information, initiate and confirm a transaction anonymously, and indicate the settlement service shall make settlement payments on behalf of the entity device;
designating, from the account information, a linked entity account and debiting the linked entity account to initiate a current account transaction history shared only with the entity device and used with secure credentials to authenticate requests for payment;
receiving, from a payee, an amount requested for payment settlement and confirmation credentials comprising a signed encrypted certificate obtained from the entity that requests the settlement service perform transactions with on behalf of the entity;
authenticating, using the one or more settlement devices, the amount requested received from the payee device and approved by the certificate obtained from the payee, using credentials, certificates, and current account transaction history sent from the entity device; and
completing, using the one or more settlement devices, the transaction between the entity device and the payee device, upon authentication, by debiting the linked entity account and crediting a designated destination belonging to the payee device, and then securely storing results of the transaction and iteratively updating the current account transaction history for future authentication.
